(19) United States
(12) Patent Application Publication
(10) Pub. No.: US 2022/0154565 A1
(43) Pub. Date: May 19, 2022

(54) SYSTEM FOR HYDRAULIC FRACTURING WITH CIRCUITRY FOR MITIGATING HARMONICS CAUSED BY VARIABLE FREQUENCY DRIVE

(71) Applicant: Siemens Energy, Inc., Orlando, FL (US)

(72) Inventors: Dalia El Tawy, Houston, TX (US); Arvind Sriraman, Houston, TX (US); Lynn Wheatcraft, Richmond, TX (US)

(21) Appl. No.: 17/439,718

(22) PCT Filed: Jul. 16, 2019
(86) PCT No.: PCT/US2019/041940

§ 371 Date: Sep. 15, 2021

Related U.S. Application Data
(60) Provisional application No. 62/839,104, filed on Apr. 26, 2019.

(51) Int. Cl. E21B 43/26; H02P 29/50; H02J 3/01

(52) U.S. Cl. CPC E21B 43/2607; H02J 3/01; H02P 29/50

(57) ABSTRACT

System for hydraulic fracturing is provided. The system may involve a mobile hydraulic fracturing subsystem including a variable frequency drive (VFD) (12) electrically coupled to a generator (50). An electric motor (14) is driven by VFD (12). Harmonic mitigation circuitry (16) is configured to mitigate harmonic distortion by VFD (12). A hydraulic pump (20) is driven by motor (14) to deliver a pressurized fracturing fluid. VFD (12), harmonic mitigation circuitry (16), motor (14) and hydraulic pump (20) may be arranged on a mobile platform (24) so that a subsystem so arranged can be transportable from one physical location to another. In some disclosed embodiments, the hydraulic fracturing subsystem may be fitted on mobile platform (24) having size and weight not subject to laws or regulations requiring a permit and/or accompaniment by an escort vehicle to travel on a public highway, such as public highways in the United States and/or Canada.

### CROSS-REFERENCE TO RELATED APPLICATIONS

This application claims benefit of the Apr. 26, 2019 filing date of U.S. provisional application 62/839,104, which is incorporated by reference herein.

### BACKGROUND

### 1. Field

Disclosed embodiments relate generally to the field of hydraulic fracturing, such as used in connection with oil and gas applications, and, more particularly, to a system for hydraulic fracturing, and, even more particularly, to system including circuitry to mitigate harmonic distortion caused by a variable frequency drive.

### 2. Description of the Related Art

Hydraulic fracturing is a process used to foster production from oil and gas wells. Hydraulic fracturing generally involves pumping a high-pressure fluid mixture that may include particles/proppants and optional chemicals at high pressure through the wellbore into a geological formation. As the high-pressure fluid mixture enters the formation, this fluid fractures the formation and creates fissures. When the fluid pressure is released from the wellbore and formation, the fractures or fissures settle, but are at least partially held open by the particles/proppants carried in the fluid mixture. Holding the fractures open allows for the extraction of oil and gas from the formation.

Certain known hydraulic fracturing systems may use large diesel engine-powered pumps to pressurize the fluid mixture being injected into the wellbore and formation. These large diesel engine-powered pumps may be difficult to transport from site to site due to their size and weight, and are equally—if not more—difficult to move or position in a remote and undeveloped wellsite, where paved roads and space to maneuver may not be readily available. Further, these large diesel engine powered pumps require large fuel storage tanks, which must also be transported to the wellsite. Another drawback of systems involving diesel engine-powered pumps is the burdensome maintenance requirements of diesel engines, which generally involve significant maintenance operations approximately every 300-400 hours, thus resulting in regular downtime of the engines approximately every 2-3 weeks. Moreover, the power-to-weight ratio of prior art mobile systems involving diesel engine-powered pumps tends to be relatively low.

To try to alleviate some of the difficulties involved with diesel engine-powered fracturing pump systems, certain electrically-driven hydraulic fracturing systems have been proposed. For an example of one approach involving an electric hydraulic system, see International Publication WO 2018/071738 A1.

### BRIEF DESCRIPTION

One disclosed embodiment is directed to a system for hydraulic fracturing that may involve a mobile hydraulic fracturing subsystem including a variable frequency drive (VFD), which may be electrically coupled to receive alternating current from a generator. An electric motor is electrically driven by the VFD. Harmonic mitigation circuitry is configured to mitigate harmonic distortion caused by the VFD. A hydraulic pump is driven by the electric motor to deliver a pressurized fracturing fluid. The VFD, the harmonic mitigation circuitry, the electric motor and the hydraulic pump may be arranged on a mobile platform so that a subsystem so arranged can be transportable from one physical location to another.

### BRIEF DESCRIPTION OF THE DRAWINGS

FIG. 1 illustrates a block diagram of one non-limiting embodiment of a disclosed system that may involve a mobile hydraulic fracturing subsystem, including circuitry to mitigate harmonic distortion, such as may be produced by a VFD; and may further involve a power-generating subsystem, mobile or otherwise.

FIG. 2 illustrates a block diagram of one non-limiting example of circuitry that may be used in a disclosed mobile hydraulic fracturing subsystem, and, without limitation, may involve a six-pulse VFD coupled to harmonic mitigation circuitry in the form of a line reactor, among other filtering mechanisms.

FIG. 3 illustrates a block diagram of another non-limiting example of further circuitry that may be optionally used in a disclosed mobile hydraulic fracturing subsystem and may involve a VFD coupled to harmonic mitigation circuitry in the form of voltage stabilizing ground reference (VSGR) circuitry.

FIG. 4 illustrates a block diagram of one non-limiting embodiment of a disclosed system that may involve a scalable, mobile hydraulic fracturing subsystem, and may further involve a scalable, power-generating subsystem, mobile or otherwise.

FIG. 5 illustrates a block diagram of one non-limiting embodiment of disclosed mobile hydraulic fracturing subsystems equipped with respective six-pulse VFDs and respective line reactors, where the mobile hydraulic fracturing subsystems may be connected in parallel circuit to a single power-generating subsystem, mobile or otherwise.

FIG. 6 illustrates a block diagram of another non-limiting example of further circuitry that may be optionally used in a disclosed mobile hydraulic fracturing subsystem.

### DETAILED DESCRIPTION

The present inventors have recognized that certain prior art systems for hydraulic fracturing that may involve use of variable frequency drives (VFDs) may suffer from various drawbacks, such as may involve reliability issues due to operation under challenging environmental conditions (e.g., extreme temperatures, high vibration, rough or uneven terrains when transported to a given site etc.) yet reliable operation remains critical to hydraulic fracturing processes.

Further drawbacks may be due to harmonic distortion resulting from switching signals in the power electronics for performing power signal modulation in the VFDs. For example, harmonic waveforms, such as may involve harmonic currents and/or harmonic voltages may be propagated back from a VFD to a power generation source connected to power the VFD. These harmonic waveforms can result in inefficiencies and over-heating of, for example, winding components in the power generation source. Still further drawbacks may result due to the typically oversized and overweight circuitry involved in certain prior art systems for hydraulic fracturing, which in turn may involve oversize and overweight vehicles for transporting such systems, and, therefore, may be subject to burdensome logistical issues involved in the permitting of oversize and overweight vehicles.

At least in view of such recognition, disclosed embodiments formulate an innovative approach in connection with systems for hydraulic fracturing that may involve use of VFDs, and concomitant circuitry designed to overcome at least the foregoing drawbacks. Disclosed embodiments are believed to cost-effectively and reliably provide the necessary VFD functionality that may be needed to electrically drive hydraulic pumps utilized in a fracturing process. This may be achieved by way of cost-effective utilization of relatively compact and light-weight circuitry that may be fitted in a vehicle having size and weight not subject to laws or regulations requiring a permit and/or accompaniment by an escort vehicle in order to travel on a public highway, such as public highways in the United States and/or Canada.

Disclosed embodiments can also offer a compact and self-contained, mobile power-generating subsystem that may be configured with smart algorithms to prioritize and determine power source allocation for optimization conducive to maximize the reliability and durability of the power sources involved while meeting the variable power demands of loads that may be involved in the hydraulic fracturing process.

In the following detailed description, various specific details are set forth in order to provide a thorough understanding of such embodiments. However, those skilled in the art will understand that disclosed embodiments may be practiced without these specific details that the aspects of the present invention are not limited to the disclosed embodiments, and that aspects of the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may. It is noted that disclosed embodiments need not be construed as mutually exclusive embodiments, since aspects of such disclosed embodiments may be appropriately combined by one skilled in the art depending on the needs of a given application.

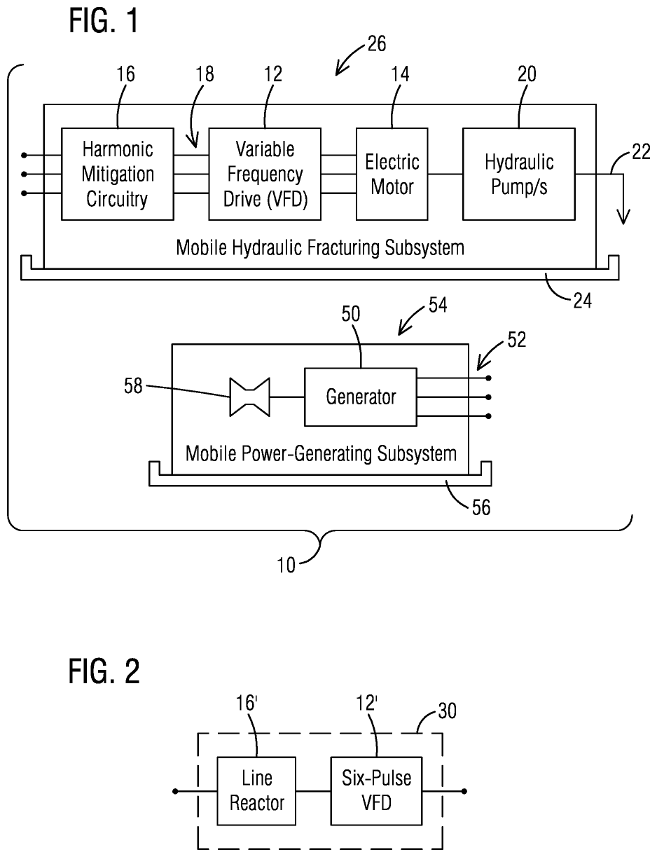

FIG. 1 illustrates a block diagram of one non-limiting embodiment of a disclosed system 10 for hydraulic fracturing, such as may involve a mobile hydraulic fracturing subsystem 26 and a power-generating subsystem 54. It will be appreciated that, although power-generating subsystem 54 in certain embodiments may be a mobile power-generating subsystem, such a subsystem need not be a mobile power-generating subsystem. In one non-limiting embodiment, a variable frequency drive (VFD) 12 in mobile hydraulic fracturing subsystem 26 may be electrically coupled to receive alternating current from a generator 50 in mobile power-generating subsystem 54.

An electric motor 14, such as without limitation, an induction motor, may be electrically driven by VFD 12. As will be appreciated by one skilled in the art, techniques involving variable speed operation of an electric motor, in addition to the term VFD, may also be referred to in the art as variable speed drive (VSD); or variable voltage, variable frequency (VVVF). Accordingly, without limitation, any of such initialisms or phrases may be interchangeably applied in the context of the present disclosure to refer to drive circuitry that may be used in disclosed embodiments for variable speed operation of an electric motor.

In one non-limiting embodiment, harmonic mitigation circuitry 16 may be connected between an input side 18 of VFD 12 and an output side 52 of generator 50 to mitigate harmonic distortion that may be caused by VFD 12. Without limitation, harmonic mitigation circuitry 16 may be effective for reducing harmonic waveforms drawn from generator 50, such as harmonic voltages and/or harmonic voltages. One or more hydraulic pumps 20 may be driven by electric motor 14 to deliver a pressurized fracturing fluid, (schematically represented by arrow 22), such as may be conveyed to a well head to be conveyed through the wellbore of the well into a given geological formation. As will be appreciated by one skilled in the art, the interface between electric motor 14 and hydraulic pump 20 may be implemented in any of a variety of ways, such as direct mechanical coupling, indirect coupling, such as by way of hydraulic means, etc.

In one non-limiting embodiment, VFD 12, electric motor 14, harmonic mitigation circuitry 16 and hydraulic pump 20 may be arranged onto a respective mobile platform 24 (e.g., a singular mobile platform) that can propel itself (e.g., a self-propelled mobile platform); or can be towed or otherwise transported by a self-propelled vehicle. That is, each of such subsystem components may be respectively mounted onto mobile platform 24 so that mobile hydraulic fracturing subsystem 26 is transportable from one physical location to another. For example, mobile platform 24 may represent a self-propelled vehicle alone, or in combination with a non-motorized cargo carrier (e.g., semi-trailer, full-trailer, dolly, skid, barge, etc.) with the subsystem components disposed onboard the self-propelled vehicle and/or the non-motorized cargo carrier. As suggested above, mobile platform 24 need not be limited to land-based transportation and may include other transportation modalities, such as rail transportation, marine transportation, etc.

Without limitation, power-generating subsystem 54 may further include a gas turbine engine 58, and, in the event power-generating subsystem 54 is a mobile system, gas turbine engine 58 may be mounted on a power generation mobile platform 56 to drive generator 50, which may also be mounted on power generation mobile platform 56, and in combination effectively form a self-contained, mobile power-generating subsystem. It will be appreciated that this self-contained, mobile power-generating subsystem may be configured to operate independent from utility power or any external power sources. Structural and/or operational features of power generation mobile platform 56 may be as described above in the context of mobile platform 24. Accordingly, mobile power-generating subsystem 54 may be transportable from one physical location to another.

In one non-limiting embodiment, gas turbine engine 58 may be (but need not be) an aeroderivative gas turbine engine, such as model SGT-A05 aeroderivative gas turbine engine available from Siemens. There are several advantages of aero-derivative gas turbines that may be particularly beneficial in a mobile fracturing application. Without limitation, an aero-derivative gas turbine is relatively lighter in weight and relatively more compact than an equivalent industrial gas turbine, which are favorable attributes in a mobile fracturing application. Depending on the needs of a given application, another non-limiting example of gas turbine engine 58 may be model SGT-300 industrial gas turbine engine available from Siemens. It will be appreciated that disclosed embodiments are not limited to any specific model or type of gas turbine engine.

In one non-limiting embodiment, as indicated in FIG. 2, the VFD used in mobile hydraulic fracturing subsystem 26 (FIG. 1) may comprise a six-pulse, VFD 12′. That is, VFD 12′ may be constructed with power switching circuitry arranged to form six-pulse sinusoidal waveforms. As will be appreciated by one skilled in the art, such VFD topology, offers at a lower cost, a relatively more compact and lighter topology than VFD topologies involving a higher number of pulses, such as 12-pulse VFDs, 18-pulse VFDs, etc. Depending on the needs of a given application any of such VHD topologies may be used in disclosed embodiments.

One non-limiting example of VFDs that may be used in disclosed embodiments may be a drive appropriately selected—based on the needs of a given hydraulic fracturing application—from the Sinamics portfolio of VFDs available from Siemens. For example, without limitation, one may use sturdy and ruggedized VFDs that have proven to be highly reliable, for example, in the challenging environment of mining applications or similar, and, consequently, are expected to be equally effective in the challenging environment of hydraulic fracturing applications. In one non-limiting embodiment, as further indicated in FIG. 2, the harmonic mitigation circuitry may comprise a passive filter, such as may involve a line reactor 16′.

In one nonlimiting embodiment, a size and weight of mobile platform 24 arranged with six-pulse VFD 12′, electric motor 14, line reactor 16′ and hydraulic pump 20 may not be subject to laws or regulations requiring a permit in order to travel on a public highway, such as public highways in the United States and/or Canada and other countries. Additionally, the size and weight of mobile platform 24 arranged with six-pulse VFD 12′, electric motor 14, line reactor 16′ and hydraulic pump 20 may not be subject to laws or regulations requiring accompaniment by an escort vehicle to travel on such public highways.

For readers desirous of background information in connection with some of the burdensome logistical issues that may be involved in state oversize/overweight permitting systems in the U.S.A, see, for example, Report No. FHWA-HOP-17-061, titled “Best Practices in Permitting Oversize and Overweight Vehicles—Final Report”, dated February 2018 and sponsored by United States Department of Transportation, Federal Highway Administration. The point being that at least some disclosed embodiments can provide a substantial advantage over prior art mobile systems for hydraulic fracturing applications that are oversized and overweight, and, therefore, are subject to the burdensome logistical issues involved in the permitting of oversize and overweight vehicles.

In one non-limiting embodiment, VFD 12′ and line reactor 16′ may be accommodated (e.g., integrated) in a common package 30, such as may involve a common cabinet. In one non-limiting embodiment, an impedance (e.g., reactive impedance) of generator 50 in combination with an inductance of line reactor 16′ may be arranged to further reduce the harmonic waveforms that may be drawn from generator 50.

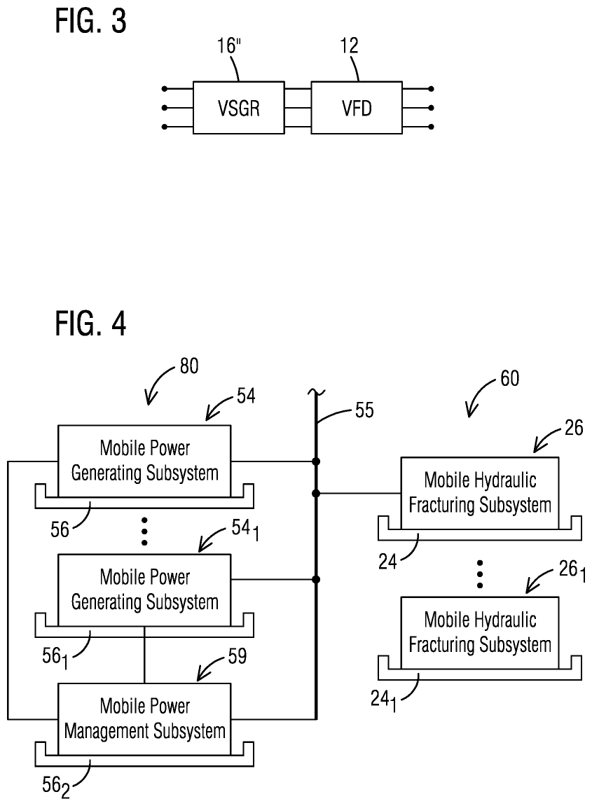

In one non-limiting embodiment, as indicated in FIG. 3, the harmonic mitigation circuitry used in mobile hydraulic fracturing subsystem 26 (FIG. 1) may involve a voltage stabilizing ground reference (VSGR) circuitry 16″, such as available from Applied Energy LLC. Without being limiting to any specific theory of operation, VSGR circuitry 16″, is described to act like a three-phase transformer when all phases are balanced. When there is a phase voltage imbalance (e.g., due to the presence of harmonics), VSGR circuitry 16″ (based on electromagnetic interaction among its windings) conceptually behaves analogous to a pull-down resistor with respect to phase/s experiencing a rise in voltage. Conversely, VSGR circuitry 16″ conceptually behaves analogous to a pull-up resistor with respect to phase/s experiencing a decrease in voltage.

In operation, phase voltages and/or currents may be stabilized and brought into balance by VSGR circuitry 16″ and, as a result, harmonics are substantially reduced, which can enable reliable and effective harmonic mitigation in certain embodiments of a disclosed system. For readers desirous of background information in connection with VSGR circuitry 16″, see U.S. Pat. No. 6,888,709 titled “Electromagnetic Transient Voltage Surge Suppression System”; see also International Publication WO 2007143605A2, titled “Electromagnetic Noise Suppression System for Wye Power Distribution”.

It will be appreciated by one skilled in the art that other alternative non-limiting approaches may be used to implement harmonic attenuation circuitry, such as by way of active filters appropriately configured to digitally create and control reactive power to cancel harmonics, or by way of phase shifting transformers. For example, presuming a three-phase line, the basic principle of a phase shifting transformer approach being to take harmonics that may be present in a given line, shift the harmonics in the given line by 180° with respect to harmonics that may be present in another line and then combine such harmonics together, and thus achieve substantial harmonics cancellation.

FIG. 4 illustrates a block diagram of one non-limiting embodiment of a disclosed system that may involve a scalable, mobile hydraulic fracturing system 60 using two or more of mobile hydraulic fracturing subsystems 26 (FIG. 1) as building blocks. By way of example, mobile hydraulic fracturing subsystem 26 may be arranged in combination with at least one further mobile hydraulic fracturing subsystem 26₁. That is, a mobile hydraulic fracturing subsystem arranged with the components described above in the context of the preceding FIGs. More specifically, a further mobile hydraulic fracturing subsystem including a further VFD, a further electric motor, further harmonic mitigation circuitry and further hydraulic pump/s, arranged on a further mobile platform 24₁. In this example, two mobile hydraulic fracturing subsystems 26 and 26₁ form scalable mobile hydraulic fracturing system 60. However, the total number of mobile hydraulic fracturing subsystems that may be arranged to form mobile hydraulic fracturing system 60 may be tailored based on the needs of a given application.

As further illustrated in FIG. 4, this non-limiting embodiment may further involve a scalable, micro-grid power-generating system 80 using two or more of mobile power-generating subsystem 54 as building blocks. By way of example, mobile power-generating subsystem 54 (FIG. 1) may be arranged with at least one further power-generating subsystem, such as mobile power-generating subsystem 54₁ (including respective further components, such as a further generator, a further gas turbine engine), arranged on a further power generation mobile platform 56₁ and electrically-connectable by way of a power bus 55 to form a scalable, micro-grid power-generating system 80 connected to power scalable mobile hydraulic fracturing system 60. In this example, two mobile power-generating subsystems 54, 54₁ form scalable, micro-grid power-generating system 80. However, the total number of mobile power-generating subsystems that may be arranged to form scalable, micro-grid power-generating system 80 may be appropriately tailored based on the needs of a given application.

An energy management subsystem 59, such as a may be arranged on another mobile platform 56₂, may be configured to execute a power control strategy configured to optimize utilization of power generated by mobile power-generating subsystems 54, 54₁ to meet variable power demands of the mobile hydraulic fracturing subsystems connected to power bus 55.

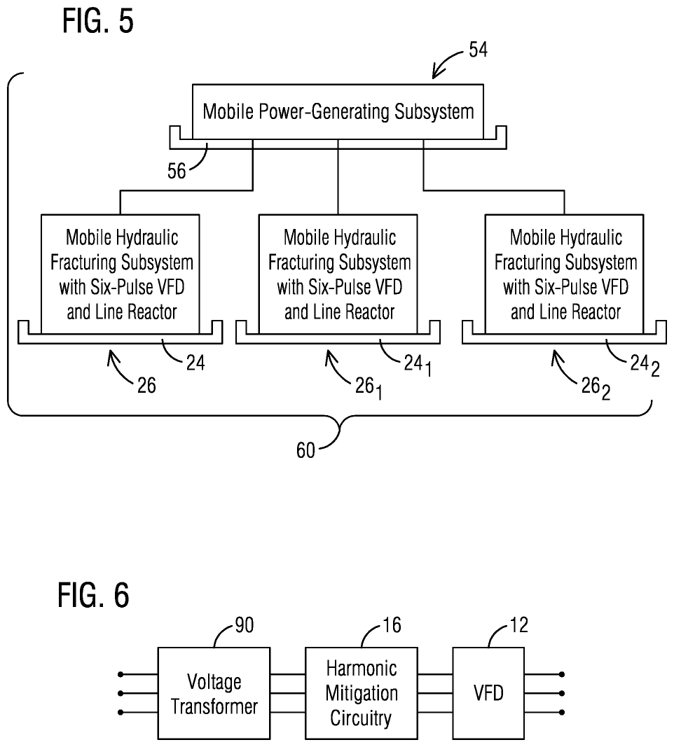

As illustrated in FIG. 5, in one non-limiting embodiment, a singular mobile power-generating subsystem 54 may be arranged to electrically power mobile scalable hydraulic fracturing system 60, such as may be made up by a plurality of mobile hydraulic fracturing subsystems. In this non-limiting example, a total of three mobile hydraulic fracturing subsystems 26, 26₁ and 26₂; each equipped with respective line reactors and respective six-pulse VFDs connected in parallel circuit to output side 52 of generator 50 (FIG. 1) of power-generating subsystem 54. This disclosed embodiment, involving six-pulse VFDs, offers a balanced and efficient approach in connection with scalability, cost, size, weight, and reliable performance within acceptable levels of total harmonic distortion (THD).

FIG. 6 illustrates a block diagram of another non-limiting example of further circuitry that may be optionally used in a disclosed mobile hydraulic fracturing subsystem. For example, depending on the voltage level that may be supplied at the output side 52 of generator 50 (FIG. 1), in certain embodiments, a voltage transformer 90 (e.g., step-down voltage transformer) may be used to step-down such a voltage to a voltage level that may be appropriate for VFD 16, such as without limitation from 13.8 kV at the output side 52 of generator 50 to 2.6 kV at the input side of VFD 12. In one non-limiting embodiment, a respective high side of voltage transformer 90 may be electrically coupled to the power bus 55 (FIG. 4). Alternatively, the respective high side of voltage transformer 90 may be electrically coupled to the output side 52 of generator 50 by way of a switchgear, circuit breaker, fuses or any such circuit-disconnecting device. In certain embodiments, voltage transformer 90 may be arranged on the respective mobile platform 24 in combination with VFD 12, electric motor 14, harmonic mitigation circuitry 16 and hydraulic pump 20

In operation, disclosed embodiments are believed to cost-effectively and reliably provide the necessary VFD functionality that may be needed to electrically drive hydraulic pumps utilized in a fracturing process. Without limitation, this may be achieved by way of cost-effective utilization of relatively compact, and light-weight circuitry that, without limitation, may be fitted in a vehicle having size and weight not subject to laws or regulations requiring a permit and/or accompaniment by an escort vehicle in order to travel on a public highway, such as public highways in the United States and/or Canada.

In operation, disclosed embodiments can also offer a compact and self-contained, mobile power-generating system that may be configured with smart algorithms to prioritize and determine power source allocation for optimization conducive to maximize the reliability and durability of the power sources involved while meeting the variable power demands of loads that may be involved in the hydraulic fracturing process.

While embodiments of the present disclosure have been disclosed in exemplary forms, it will be apparent to those skilled in the art that many modifications, additions, and deletions can be made therein without departing from the scope of the invention and its equivalents, as set forth in the following claims.

1. A system for hydraulic fracturing, the system comprising:
a variable frequency drive electrically coupled to receive alternating current from a generator;
an electric motor electrically driven by the variable frequency drive; and
harmonic mitigation circuitry to mitigate harmonic distortion by the variable frequency drive, the harmonic mitigation circuitry connected between an input side of the variable frequency drive and an output side of the generator, thereby reducing harmonic waveforms drawn from the generator; and
a hydraulic pump driven by the electric motor, the hydraulic pump arranged to deliver a pressurized fracturing fluid,
wherein the variable frequency drive, the electric motor, the harmonic mitigation circuitry and the hydraulic pump being arranged on a respective mobile platform.

2. The system of claim 1, wherein the variable frequency drive comprises a six-pulse variable frequency drive.

3. The system of claim 1, wherein the harmonic mitigation circuitry comprises a line reactor.

4. The system of claim 3, wherein a reactive impedance of the generator in combination with an inductance of the line reactor is arranged to further reduce the harmonic waveforms drawn from the generator.

5. The system of claim 4, further comprising a common package for the variable frequency drive and the line reactor.

6. The system of claim 2, wherein the harmonic mitigation circuitry comprises a voltage stabilizing ground reference circuitry.

7. The system of claim 2, wherein the generator is part of a mobile power-generating subsystem arranged on a power generation mobile platform, wherein the mobile power-generating subsystem comprises a gas turbine engine mounted on the power generation mobile platform to drive the generator.

8. The system of claim 7, wherein the variable frequency drive, the electric motor, the harmonic mitigation circuitry and the hydraulic pump being arranged on the mobile platform constitutes a mobile hydraulic fracturing subsystem that may be arranged with at least one further mobile hydraulic fracturing subsystem to form a scalable mobile hydraulic fracturing system, each of the least one further mobile hydraulic fracturing subsystem comprising a further variable frequency drive, a further electric motor, further harmonic mitigation circuitry and a further respective hydraulic pump being arranged on a further mobile platform.

9. The system of claim 7, wherein the mobile power-generating subsystem is arranged to electrically power the mobile hydraulic fracturing system and the at least one further mobile hydraulic fracturing subsystem of the scalable mobile hydraulic fracturing system, wherein the mobile hydraulic fracturing subsystem and the at least one further mobile hydraulic fracturing subsystem of the scalable mobile hydraulic fracturing system is each connected in parallel circuit to the output side of the generator of the mobile power-generating subsystem.

10. The system of claim 9, wherein a total number of mobile hydraulic fracturing subsystems of the mobile hydraulic fracturing system that are connected in parallel circuit to the output side of the generator of the power-generating system consists of three mobile hydraulic fracturing subsystems.

11. The system of claim 2, wherein a size and weight of the mobile platform arranged with the six-pulse variable frequency drive, the harmonic mitigation circuitry, the electric motor and the hydraulic pump is not subject to laws or regulations requiring a permit in order to travel on a public highway.

12. The system of claim 2, wherein the size and weight of the mobile platform arranged with the six-pulse variable frequency drive, the harmonic mitigation circuitry, the electric motor, and the hydraulic pump is not subject to laws or regulations requiring accompaniment by an escort vehicle to travel on a public highway.

13. The system of claim 7, further comprising an electrically-connectable power bus arranged to form a scalable mobile micro-grid power-generating system in combination with at least a further one of the mobile power-generating subsystem, each of the at least further one of the mobile power-generating subsystem comprising a further generator and a further gas turbine engine being arranged on a further power generation mobile platform.

14. The system of claim 13, further comprising an energy management subsystem configured to execute a power control strategy configured to optimize utilization of power generated by the mobile power-generating subsystem and by said at least further one of the mobile power-generating subsystem to meet variable power demands of a number of mobile hydraulic fracturing subsystems connected to the power bus.

15. The system of claim 13, wherein the mobile hydraulic fracturing subsystem and the at least one further mobile hydraulic fracturing subsystem each comprises a respective voltage transformer having a respective high side electrically coupled to the power bus and a respective low-side electrically coupled to supply alternating current to a respective input side of the respective variable frequency drives of the mobile hydraulic fracturing subsystem and the at least one further mobile hydraulic fracturing subsystem.

16. The system of claim 1, further comprising a voltage transformer having a high side electrically coupled to the output side of the generator and a low side electrically coupled to supply alternating current to the input side of the variable frequency drive.

17. The system of claim 16, wherein the voltage transformer is arranged on the respective mobile platform.

18. The system of claim 1, wherein the respective mobile platform is a singular mobile platform shared in common by the variable frequency drive, the electric motor, the harmonic mitigation circuitry and the hydraulic pump.
